(19) United States
(12) Patent Application Publication
(10) Pub. No.: US 2017/0198737 A1
(43) Pub. Date: Jul. 13, 2017

(54) SLEEVE-TYPE MORTISE-AND-TENON JOINT STRUCTURE UNIT AND APPLICATION THEREOF

(71) Applicant: Zhijun YANG, Guangzhou (CN)

(72) Inventor: Zhijun YANG, Guangzhou (CN)

(21) Appl. No.: 15/314,948

(22) PCT Filed: May 15, 2015
(86) PCT No.: PCT/CN2015/079020

§ 371 Date: Nov. 30, 2016

(30) Foreign Application Priority Data
May 30, 2014 (CN) 201410239228.6

(51) Int. Cl. F16B 17/00

(52) U.S. Cl. CPC F16B 17/00

(57) ABSTRACT

Disclosed is a sleeve-type mortise-and-tenon joint structure unit, comprising: an externally wrapping pipe-type frame (1) and several internally supported pipe-type frames (2) disposed in the externally wrapping pipe-type frame. The externally wrapping pipe-type frame is provided with several openings (3). After some or all of the internally supported pipe-type frames are pulled out of an end part of the externally wrapping pipe-type frame, a vacant part (4) is formed in the externally wrapping pipe-type frame, and the openings and the vacant part form a mortise structure. Further disclosed are two applications of the sleeve-type mortise-and-tenon joint structure unit. The above-mentioned sleeve-type mortise-and-tenon joint structure unit has the advantages of requiring no nail or binder, a stable structure, rapid and convenient assembly and disassembly, durability, lightweightness, reusability, and environmental friendliness.

### TECHNICAL FIELD

The present invention relates to an assembly structure, and particularly relates to a sleeve-type mortise-and-tenon joint structure unit and an application thereof, which can be applied to the technical field comprising engineering construction, furniture, toys, package and the like related to a mortise-and-tenon joint structure.

### BACKGROUND

A mortise-and-tenon joint structure is a structural method with a wooden framework structure served as a main method and wood and bricks served as main building materials of Chinese ancient buildings, and is constructed by a primary component such as an upright column, a lateral beam and a purlin, joint points of all the components are matched via a mortise-and-tenon joint, thereby constituting a resilient frame. The mortise-and-tenon joint is a very ingenious invention, and a connection method for such a component enables a traditional Chinese wooden structure to become a specially flexible structure which surpasses a bent, a frame or a rigid frame in current construction, which not only can bear a larger load, but also allows to produce a certain deformation to offset certain earthquake energy by deformation under an earthquake load and to reduce a response of the structure to the earthquake.

The mortise-and-tenon joint is a connection method of using a concave-convex combination on two wooden components. A convex part is called a tenon (or a tenon end); a concave part is called a mortise (or a mortise hole, a mortise structure), and the tenon and the mortise are interlocked to serve the function of connection. This is a main structural method of Chinese ancient buildings, furniture and the other wooden instrument devices. The mortise-and-tenon structure is a combination of the tenon and the mortise, is an ingenious combination of more and less, high and low, and long and short between wooden members, and can effectively limit the wooden members to twist towards different directions. The most basic mortise-and-tenon joint structure consists of two components, and one tenon end of the mortise-and-tenon joint structure is inserted into the other mortise hole, thereby connecting and fixing the two components.

However, the existing mortise-and-tenon joint structure is generally a frame connected by a solid wooden strip, and has the following disadvantages: 1. A wooden strip with a mortise structure and a wooden strip with a tenon end are both solid structures, the weights being relatively large, and can only be replaced in a stacked manner in sequence during the transportation, which occupies a larger space. 2. There is a big difficulty in processing the wooden mortise structure and the wooden tenon end. 3. Once a frame is processed and formed, the frame has a strong dedicated usability and can not be reused.

Contents of the Invention

With regard to the technical problem existing in the prior art, the object of the present invention is to provide a sleeve-type mortise-and-tenon joint structure unit which saves a space during transportation, is convenient to be processed, has a wide usage, and the characteristic of space retaining of a pipe type is used to innovate a traditional mortise-and-tenon joint structure to enable the mortise-and-tenon joint structure to become a structure which can be varied and combined at any time, can continued to be further strengthened, and is more stable.

Another object of the present invention is to provide an application of using a sleeve-type mortise-and-tenon joint structure unit in a product package, the structure is simple, the product is protected all around, and the sleeve-type mortise-and-tenon joint structure unit has functions of anti-vibration, anti-crashing and anti-abrasion.

Yet another object of the present invention is to provide an application of constituting a frame structure with a sleeve-type mortise-and-tenon joint structure unit, which requires no nail or binder, has a stable structure, is rapidly and conveniently assembled and disassembled, and has durability, lightweightness, reusability, and environmental friendliness.

In order to achieve the above-mentioned objects, the present invention adopts the following technical solutions:

a sleeve-type mortise-and-tenon joint structure unit, which comprises one externally wrapping pipe-type frame and several internally supported pipe-type frames embedded in the externally wrapping pipe-type frame; the externally wrapping pipe-type frame is provided with several openings, after some or all of at least one internally supported pipe-type frames are pulled out of an end part of the externally wrapping pipe-type frame, a vacant part is formed in the externally wrapping pipe-type frame, and the openings and the vacant part form a mortise structure.

The cross section of the externally wrapping pipe-type frame is in a regular circular shape or in a regular polygonal shape. Several special shapes needed to be described: a regular circular shape is used to have better resilience, has the function of buffering when being applied in product packaging, and effectively protect the product; a triangular shape is used to have a better characteristic of position concession, is particularly suitable for the package of a special-shaped product, and can be adapt to shapes of multiple kinds of products; a square shape is used to have a better positioning characteristic, is not easy to move when the product is packed, and is stable in structure when constituting a structure of a three-dimensional space; using a regular hexagonal shape can have the characteristics of the above-mentioned three.

The cross section of the internally supported pipe-type frame is one or more of the regular circular shape and the regular polygonal shape. Several special shapes needed to be described: a regular circular shape is used to have better resilience, has the function of buffering when being applied in product packaging, and effectively protect the product; a triangular shape is used to have a better characteristic of position concession, is particularly suitable for the package of a special-shaped product, and can be adapt to shapes of multiple kinds of products; a square shape is used to have a better positioning characteristic, is not easy to move when the product is packed, and is stable in structure when constituting a structure of a three-dimensional space; using a regular hexagonal shape can have the characteristics of the above-mentioned three.

The cross section of the externally wrapping pipe-type frame is any one of the regular circular shape and the regular polygonal shape, the cross section of the internally supported pipe-type frame is any one of the regular circular shape and the regular polygonal shape, the number of the internally supported pipe-type frames is the square of n, wherein n is a positive integer, and the shapes and the sizes of the cross sections of all the internally supported pipe-type frames in the one externally wrapping pipe-type frame are all the same. Such a structure is performing a standardized design to make the universality and the ductility of the sleeve-type mortise-and-tenon joint structure unit stronger.

The width of the opening corresponds to the height or the width of the internally supported pipe-type frame. The definitions of the height and the width of the internally supported pipe-type frame and the externally wrapping pipe-type frame as mentioned herein: the internally supported pipe-type frames are placed on a plane, the distance between left and right ends is the width, and the distance between upper and lower ends is the height. For example, with regard to the regular circular shape, the width and the height are both a diameter of the regular circular shape; with regard to the regular triangular shape, a side length is the width, and a height is the height; with regard to the square shape, the width and the height are both a side length; with regard to a regular pentagonal shape, the distance between left and right angles on the cross section is the width, the distance between an upper corner and a lower side is the height; and so on. The correspondence herein refers to being approximately the same, an error originates from the factor such as product processing, a wall thickness and deformation of an external force.

The externally wrapping pipe-type frame comprises a buffer edge, and the width of the buffer edge corresponds to the height or the width of the internally supported pipe-type frame; the buffer edge is adjacent to the openings. The buffer edge is an edge left on a pipe wall of the externally wrapping pipe-type frame after the openings are provided. After such a structure is provided, when being used for packaging a product and after the product is inserted into the mortise structure, the pulled-out internally supported pipe-type frames are padded between products and between a product and a package box, and the pulled-out internally supported pipe-type frame and the buffer edge together support the product.

In the length direction, the opening is located at an end part or between two ends of the externally wrapping pipe-type frame; in the direction of the cross section, the opening covers a part of the cross section or penetrates through the whole cross section.

An edge of the opening is of a plain end or is in a jagged shape. The jagged shape enables an opening part to have certain resilience compared with a plain shape, which has a stronger applicability (being adapt to one size range) for a tolerance of the thickness of the product and has a stronger buffer capacity for the protection of the product.

An application of the sleeve-type mortise-and-tenon joint structure unit, a product is packed by using not less than two groups of sleeve-type mortise-and-tenon joint structure units; all groups of the sleeve-type mortise-and-tenon joint structure units are provided surrounding the product, and the product is clamped into mortise structures of all groups of sleeve-type mortise-and-tenon joint structure units at the same time; the product together with all groups of the sleeve-type mortise-and-tenon joint structure units are put into a package box, and the pulled-out internally supported pipe-type frames are padded between the product and the package box.

The application of the sleeve-type mortise-and-tenon joint structure unit, a frame is constituted by using not less than two groups of sleeve-type mortise-and-tenon joint structure units, the pulled-out internally supported pipe-type frames are inserted into a mortise as a tenon end, and the pulled-out internally supported pipe-type frames connect the externally wrapping pipe-type frame together.

The principle of the present invention is:

an internally supported pipe-type frame is pulled out from an externally wrapping pipe-type frame, a vacant part is formed in the externally wrapping pipe-type frame; an opening is processed via a paper cutting machine on the externally wrapping pipe-type frame, the opening and the vacant part form a mortise structure; adjusting the shape and the size of the opening which are processed by the paper cutting machine and matching the shape and the size with the number of the pulled-out internally supported pipe-type frame can determine the shape and the size of the mortise structure.

A sleeve-type structure is used to save a transportation space and is matched with flexible arrangement of an opening to flexibly arrange a mortise structure; when a product is inserted into the mortise structure to perform product packaging, the product is served as a tenon end to constitute a mortise-and-tenon joint type structure with the mortise structure to limit the position of the product; when the pulled-out internally supported pipe-type is served as the tenon end to constitute the mortise-and-tenon joint type structure with the mortise structure, the externally wrapping pipe-type frame and the internally supported pipe-type frame criss-cross to constitute a frame, and at this time, the frame can be used in the position limitation of the product package or constituting frame-shaped furniture.

Performing standardized design for the externally wrapping pipe-type frame and the internally supported pipe-type frame satisfy the following at the same time: 1. a pipe-type frame must comply with the standard of the shape of the cross sections in an unlimited length being equal; 2. the cross section of the pipe-type frame must be a regular circle or a general regular polygon; 3. when two or more pipe-type frames of random shapes constitute a structure, the wall thicknesses of the pipe-type frames of the same category must be equal, and at the same time, the widths or the heights of the cross sections must be the same; 4. when the internally supported pipe-type frames are filled in the externally wrapping pipe-type frame to use, the number of the internally supported pipe-type frames must comply with a proportional criteria of being the square of N, wherein the N is a positive integer. In this way, when the case where the structure is needed to continue to be further strengthened occurs, a next stage of internally supported pipe-type frame is filled in the internally supported pipe-type frame referring to the same rule, and so on. The standardized design enables the same pipe-type frame to have a stronger applicability, and avoids resource waste and increase in costs caused by individual customization. The mortise-and-tenon joint structure, compared with a current conventional application, is enabled to have a wider creation space, is more portable, and saves more materials.

A pair of concave handles are provided on the externally wrapping pipe-type frame, one of the handles being located at a head-end of the externally wrapping pipe-type frame and the other handle being located at a tail end of the externally wrapping pipe-type frame.

In summary, the present invention has the following advantages:

1. using a hollow pipe-type structure to save a material to the largest extent. At the same time, because of the characteristic of space retaining of a pipe type frame, the pipe type frame has an extended ability of being able to further strengthen the structure at any time.

2. The pipe-type frame itself has had the abilities of anti-vibration and anti-crashing, and therefore, the requirement for outer packing of the product can be lowered to the lowest standard, thereby effectively saving a package cost.

3. The structure is simple and the manufacturing is convenient, punching manufacturing can be performed only by using a paper cutting machine which is conventionally used in current printing industry and can be finished by die cutting for one time. At the same time, jagged (corrugated) processing is performed for a punching cutter so that the same texture can be realized at the opening, which produces an extra effect of anti-vibration and anti-crashing and makes the package more effective. At the same time, the same technical solution can also manufacture a finger lock type handle on the externally wrapping pipe-type frame, which more facilitates a customer to pick up the product in the package.

4. The design is flexible, a corresponding externally wrapping pipe-type frame and internally supported pipe-type frames are selected in accordance with the weight of the product, the number of the package and the protection requirement in the logistics process, and then, punching is performed in accordance with the thickness of the product and the corresponding number (the value of the width of the interval between products and between the product and the package box executes the width or the height of the internally supported pipe-type frame), which can be adapted to a package requirement for the product of any size and any number. In other words, after the standardized design, a package material can not be limited by the requirements of a single batch of package orders, a conventional material preparation for production in a large batch is implemented, the cost of the package material is lowered as far as possible, the price pressure produced due to a product manufacturer performing corresponding packaging customization in accordance with the number of the orders of the product is lowered, so as to provide a strong and powerful support of price advantage for the product price and then to enable the customer to no longer pay a high price for the product package.

5. On the premise that the thicknesses of the products (for example, a marble profile, a ceramic tile, and a glass plate etc.) are the same or the diameters (for example, a lamp pipe, a glass cup etc.) are the same, the package material can be randomly adapted to use without being effected by the area and length of the product.

6. Various solutions and unlimited combinations of horizontal positioning and vertical positioning, and an outside edge and a middle partition and the like are produced via flexible and varied punching methods, which saves the package space to the largest extent.

7. The usage is convenient, the size of all groups of sleeve-type mortise-and-tenon joint structure units in a single design is correspondingly equal and unified and can be used randomly without a package component being numbered and marked complicatedly such as upper, lower, left, right, front or rear. The efficiency of industrial packaging of the product is improved to the largest extent.

8. The protection is all-round, and a point, a line and a plane of the product can be protected all around.

9. The structure is strong, and the package material can be used repeatedly, is not easy to be abrasive, thereby effectively saving a resource.

10. By means of further designing the punching for the externally wrapping pipe-type frame, the customer is enabled to additionally obtain more than one group of furniture products assembled by using the above package material, the application function of the product comprises a wok stand, a shoe rack, a flower stand, a commodity shelf, a table, a stool and a box and the like. The application range thereof comprises home, office and the like, which enables a package material to obtain a second life, thereby effectively improving a resource utilization efficiency and protecting an earth ecological environment.

### BRIEF DESCRIPTION OF THE DRAWINGS

FIG. 1 is a perspective view of a sleeve-type mortise-and-tenon joint structure unit of a first example.

FIG. 2 is a perspective view of a sleeve-type mortise-and-tenon joint structure unit of a second example.

FIG. 3 is a perspective view of a sleeve-type mortise-and-tenon joint structure unit of a third example.

FIG. 4 is a perspective view of packaging a product by using the sleeve-type mortise-and-tenon joint structure unit in FIG. 1.

FIG. 5 is a perspective view of strengthening a part by using a pulled-out internally supported pipe-type frame of FIG. 4.

FIG. 6 is a perspective view of a sleeve-type mortise-and-tenon joint structure unit of a fourth example.

FIG. 7 is a perspective view of packaging a product by using the sleeve-type mortise-and-tenon joint structure unit in FIG. 6.

FIG. 8 is a perspective view of using two types of sleeve-type mortise-and-tenon joint structure units to package a product in a fifth example.

FIG. 9 is a perspective view of a sleeve-type mortise-and-tenon joint structure unit of a sixth example.

FIG. 10 is a perspective view of a sleeve-type mortise-and-tenon joint structure unit of a seventh example.

FIG. 11 is a perspective view of a sleeve-type mortise-and-tenon joint structure unit of an eighth example.

FIG. 12 is a perspective view of a sleeve-type mortise-and-tenon joint structure unit of a ninth example.

FIG. 13 is a perspective view of a sleeve-type mortise-and-tenon joint structure unit of a tenth example.

FIG. 14 is a structural schematic view of packaging a product in a shape of a round disk by using the sleeve-type mortise-and-tenon joint structure unit in FIG. 11.

FIG. 15 is a structural schematic view of the sleeve-type mortise-and-tenon joint structure unit of 11th example being used for packaging a lamp pipe.

FIG. 16 is a structural schematic view of the sleeve-type mortise-and-tenon joint structure unit of 12th example being used for constituting a frame.

FIG. 17 is a structural schematic view of the sleeve-type mortise-and-tenon joint structure unit of 13th example being used for constituting a frame.

FIG. 18 is a structural schematic view of the sleeve-type mortise-and-tenon joint structure unit of 14th example being used for constituting a frame.

FIG. 19 is a structural schematic view of the sleeve-type mortise-and-tenon joint structure unit of 15th example being used for constituting a frame.

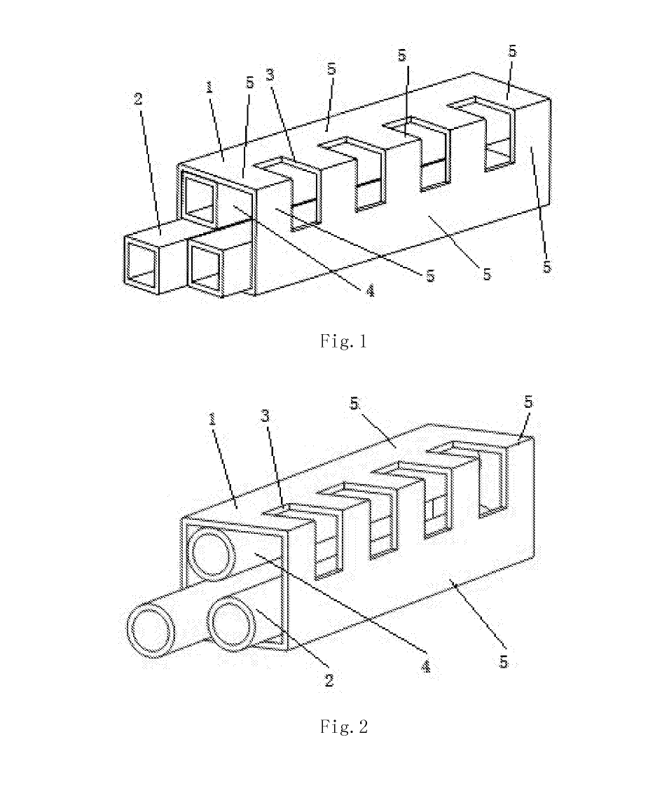

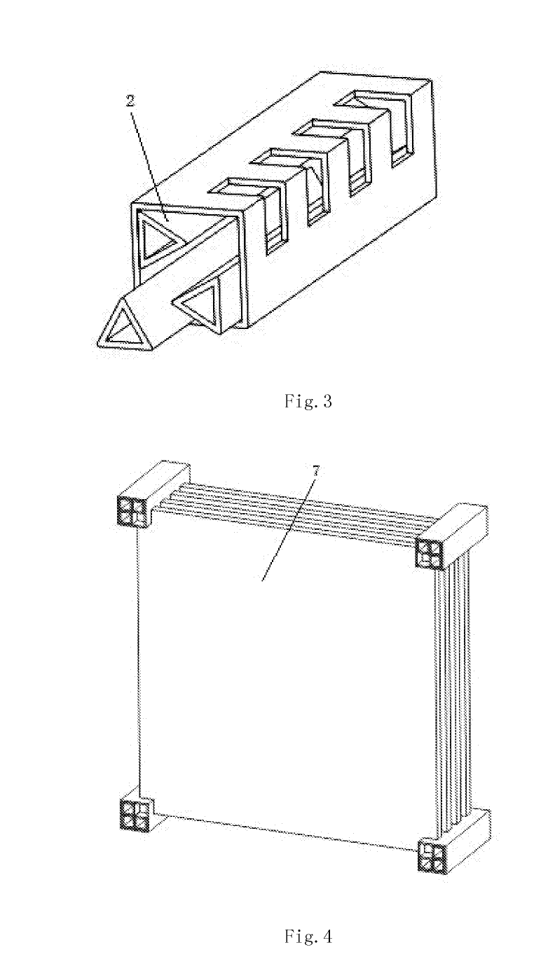

1 is an externally wrapping pipe-type frame, 2 is an internally supported pipe-type frame, 3 is an opening, 4 is a vacant part, 5 is a buffer edge, 6 is a handle, and 7 is a product.

### SPECIFIC EMBODIMENTS

Hereafter the present invention is further described in detail combined with drawings and particular embodiments.

### FIRST EXAMPLE

A sleeve-type mortise-and-tenon joint structure unit comprises an externally wrapping pipe-type frame and four internally supported pipe-type frames.

The cross section of the externally wrapping pipe-type frame is in a square shape, the externally wrapping pipe-type frame is provided with four side edges, which are respectively a first side edge, a second side edge, a third side edge and a fourth side edge, the second side edge and the third side edge are respectively adjacent to the first side edge. The externally wrapping pipe-type frame is provided with a plurality of openings, and the openings are provided at intervals in parallel along the length direction of the externally wrapping pipe-type frame. After the externally wrapping pipe-type frame is unfolded, the openings are in a rectangular shape and penetrate the first side edge; the distance from the second side edge to the nearest side edge of the openings, the distance from the third side edge to the nearest side edge of the openings, the distance from a frontmost end of the externally wrapping pipe-type frame to the nearest side edge of a first opening, the distance from a rearmost end of the externally wrapping pipe-type frame to the nearest side edge of the last opening are the widths of buffer edges and all correspond to the width of the internally supported pipe-type frames. The correspondence mentioned herein does not refer to that the size is the same but the size is approximately the same, an error originates from the factor such as the wall thickness of the externally wrapping pipe-type frame and the deformation of the internally supported pipe-type frames after being suppressed, all of the internally supported pipe-type frames being able to be placed in the externally wrapping pipe-type frame and the internally supported pipe-type frames being able to be padded between the product and the package box or the internally supported pipe-type frames being able to be padded between products to serve the function of supporting are all that are needed to the satisfied.

The cross section of the internally supported pipe-type frame is in a square shape, and providing a hollow structure can better save the material and reduce the weight. The length of the internally supported pipe-type frame is the same as the length of the externally wrapping pipe-type frame. The width of the internally supported pipe-type frame is the side of the square. In this example, the structures of the internally supported pipe-type frames are completely the same, and can realize mass production.

In the length direction, the openings are located between two ends of the externally wrapping pipe-type frame; in the direction of the cross section, the openings cover a part of the cross section.

The pipe-type frame can select carton paper, wood and plastics and the like.

During the storage, a sleeve-type structure is used to save a space to the largest extent so as to save a transportation cost in wrapping the material to the largest extent, and the externally wrapping pipe-type frame can protect the internally supported pipe-type frames in strength to the largest extent and ensures that the internally supported pipe-type frames can not be destroyed after being placed in a stacked manner.

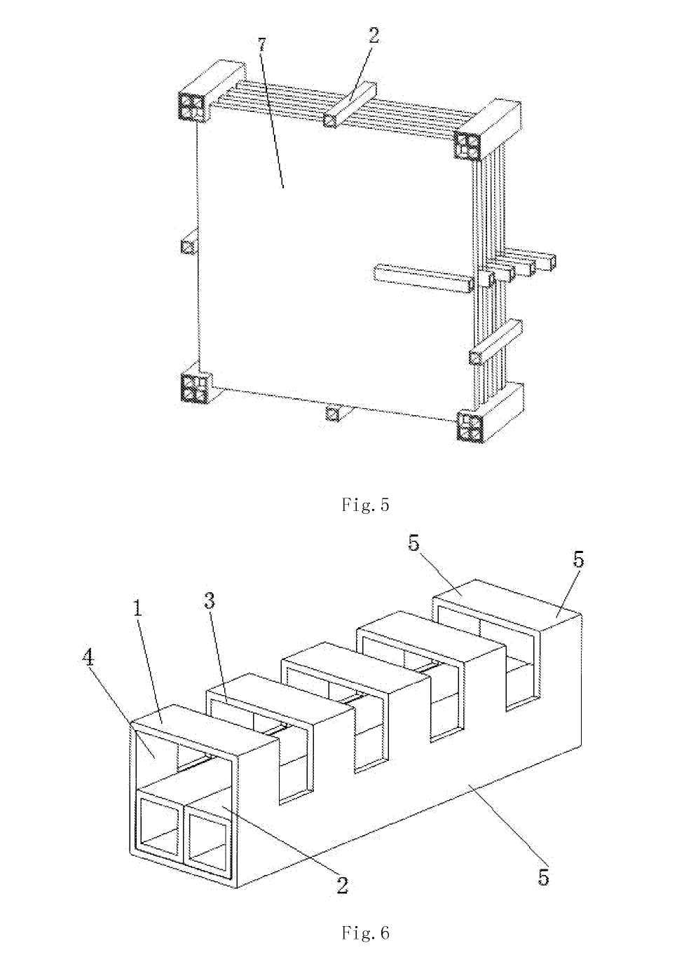

The product in the present example is rectangular glass. When the product is packed, as shown in FIG. 4, one of the internally supported pipe-type frames in the sleeve-type mortise-and-tenon joint structure unit is pulled out to form a vacant part on the first side edge of the externally wrapping pipe-type frame, and the vacant part and the plurality of openings form a plurality of mortise structures. Four sleeve-type mortise-and-tenon joint structure units correspond to four corners, and after the package is finished, products are parallel to each other. The number of the openings corresponds to the number of the products which can be packed. The products together with the sleeve-type mortise-and-tenon joint structure units are placed into the package box.

As shown in FIG. 5, when the products are relatively heavy, or the sleeve-type mortise-and-tenon joint structure units can not support the products, the pulled-out internally supported pipe-type frames can be placed in the directions of upper, lower, left, right, and can be padded between the product and the package box to further protect the product. Superfluous internally supported pipe-type frames produced by mass production can be padded between the products to perform further protection, and at this time, the interval between the openings also should correspond to the width of the internally supported pipe-type frames. The products, the sleeve-type mortise-and-tenon joint structure units and the padded internally supported pipe-type frames are integrally placed into the package box.

### SECOND EXAMPLE

In the present example, the cross section of the internally supported pipe-type frame is in the shape of a regular circle, and providing a hollow structure can better save the material and reduce the weight.

The part which is not mentioned in the present example is the same as the example I.

### THIRD EXAMPLE

In the present example, the cross section of the internally supported pipe-type frame is in the shape of an equilateral triangle, and providing a hollow structure can better save the material and reduce the weight.

The part which is not mentioned in the present example is the same as the example I.

### FOURTH EXAMPLE

A sleeve-type mortise-and-tenon joint structure unit comprises an externally wrapping pipe-type frame and four internally supported pipe-type frames.

The cross section of the externally wrapping pipe-type frame is in a square shape, the externally wrapping pipe-type frame is provided with four side edges, which are respectively a fifth side edge, a sixth side edge, a seventh side edge and an eighth side edge adjacent to each other in sequence. The externally wrapping pipe-type frame is provided with a plurality of openings, and the openings are provided at intervals in parallel along the length direction of the externally wrapping pipe-type frame. After the externally wrapping pipe-type frame is unfolded, the openings are in a rectangular shape and penetrate the fifth side edge and the sixth side edge; the distance from the seventh side edge to the nearest side edge of the openings, the distance from the eighth side edge to the nearest side edge of the openings, the distance from a frontmost end of the externally wrapping pipe-type frame to the nearest side edge of a first opening, the distance from a rearmost end of the externally wrapping pipe-type frame to the nearest side edge of the last opening are the widths of buffer edges and all correspond to the width and the height of the internally supported pipe-type frames.

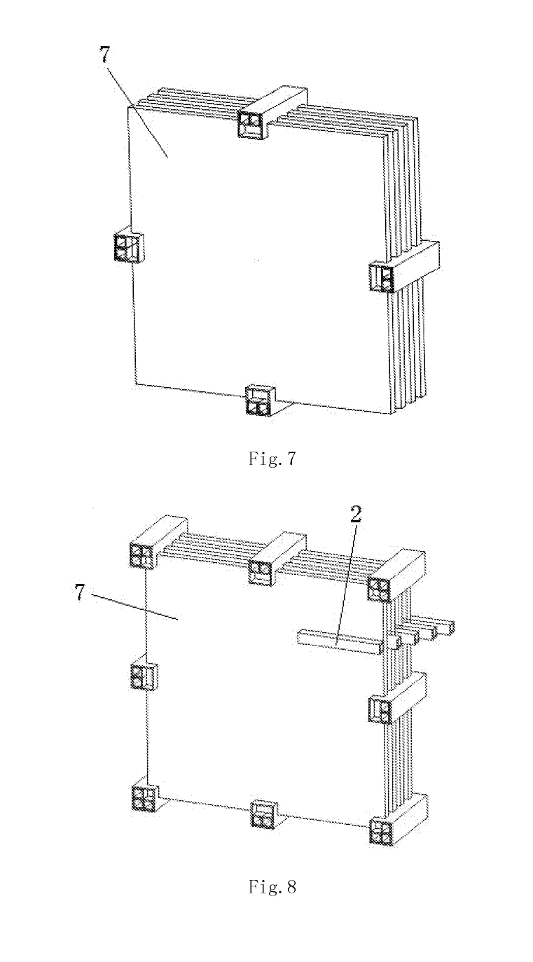

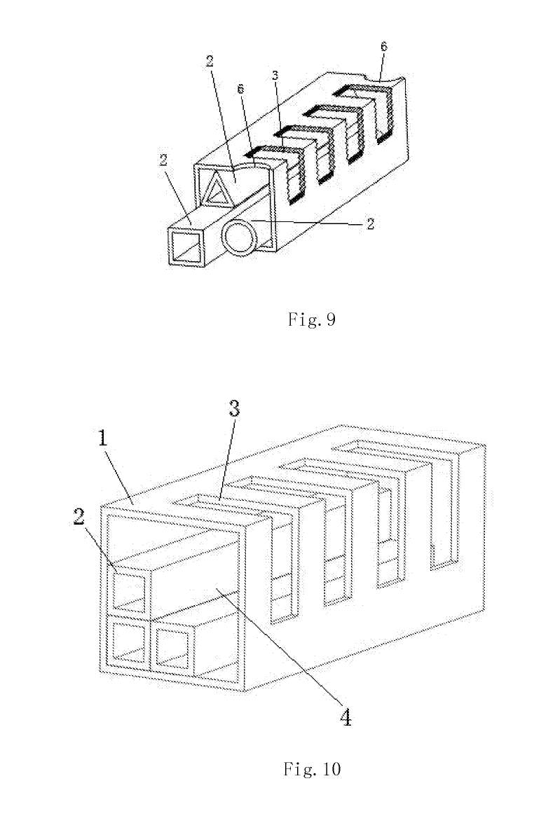

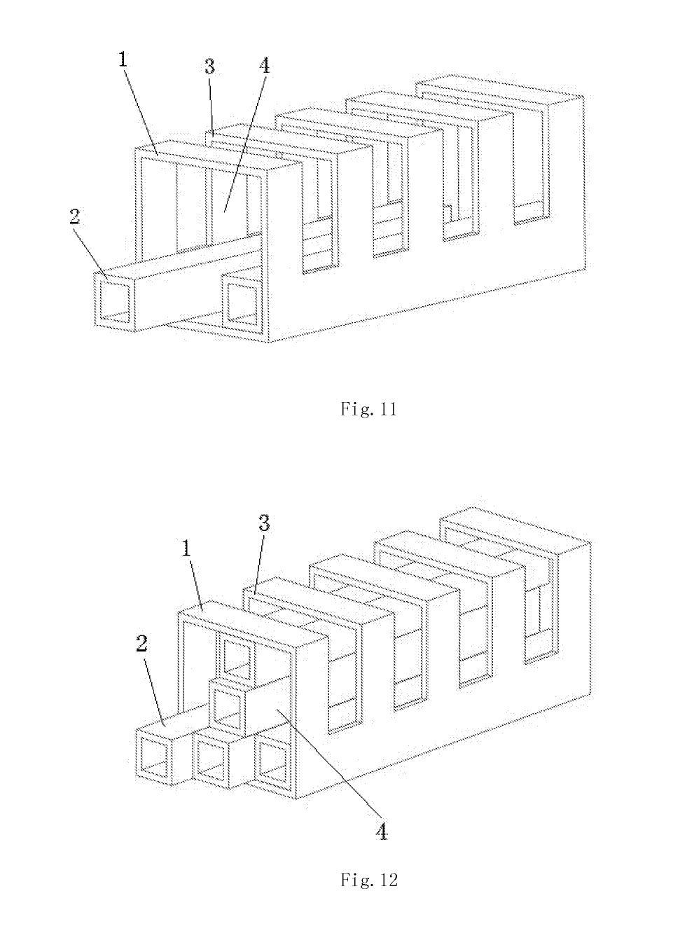

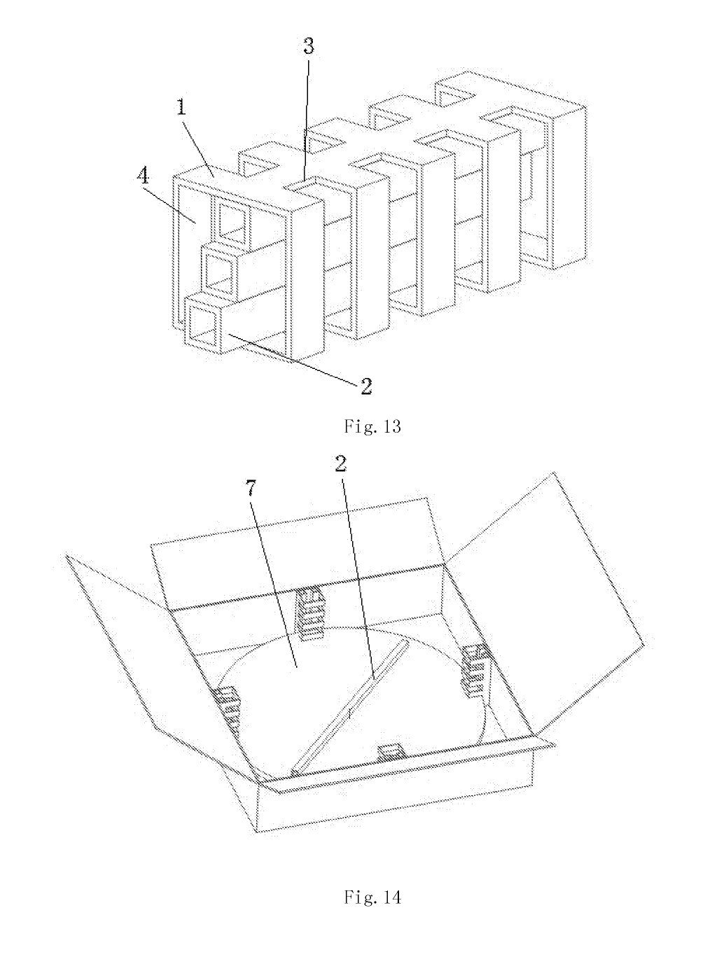

When the product is packed, as shown in FIG. 7, two of the internally supported pipe-type frames in the sleeve-type mortise-and-tenon joint structure unit is pulled out to form a vacant part on the fifth and the sixth side edges of the externally wrapping pipe-type frame, and the vacant part and the plurality of openings form a plurality of mortise structures. Four sleeve-type mortise-and-tenon joint structure units correspond to four sides, and after the package is finished, products are parallel to each other. The number of the openings corresponds to the number of the products which can be packed. The products together with the sleeve-type mortise-and-tenon joint structure units are placed into the package box.

The part which is not mentioned in the present example is the same as the example I.

### FIFTH EXAMPLE

In the present example, the sleeve-type mortise-and-tenon joint structure unit as described in the example I and the sleeve-type mortise-and-tenon joint structure units as described in example IV to package a tile in the shape of a rectangular plate.

As shown in FIG. 8, four sleeve-type mortise-and-tenon joint structure units are used to package four corners of all the products, and another type of four sleeve-type mortise-and-tenon joint structure units are used to package four sides of all the products, and the pulled-out internally supported pipe-type frames are padded between front and rear sides and the package box and are padded between the products to be placed into the package box integrally.

The differences between the two types of the sleeve-type mortise-and-tenon joint structure units only lie in the sizes and the positions of openings of the two.

The part which is not mentioned in the present example is the same as the examples I and IV.

### SIXTH EXAMPLE

In the present example, the cross section of the internally supported pipe-type frame is in the shapes of an equilateral triangle, a regular circle and a square, and providing a hollow structure can better save the material and reduce the weight. A pair of concave handles are provided on the externally wrapping pipe-type frame, one of the handles being located at a head-end of the externally wrapping pipe-type frame and the other handle being located at a tail end of the externally wrapping pipe-type frame. An edge of the opening is in a jagged shape.

The part which is not mentioned in the present example is the same as the examples I to III.

### SEVENTH EXAMPLE

The cross section of the externally wrapping pipe-type frame is in a square shape, the cross section of the internally supported pipe-type frame is in a square shape, the width of an outer frame of the internally supported pipe-type frame is one-third of the width of an inner ring of the externally wrapping pipe-type frame, and therefore a standardized design of a nine patch arrangement is realized. An opening is provided at one corner of the externally wrapping pipe-type frame and the length of the opening covers three patches of the internally supported pipe-type frames. After six inner internally supported pipe-type frames are pulled out, the externally wrapping pipe-type frame can be applied to the package of corners of a product (see FIG. 5 for a package method). The difference from FIG. 5 lies in that more internally supported pipe-type frames can be pulled out to limit the positions of the products.

The part which is not mentioned in the present example is the same as the example I.

### EIGHTH EXAMPLE

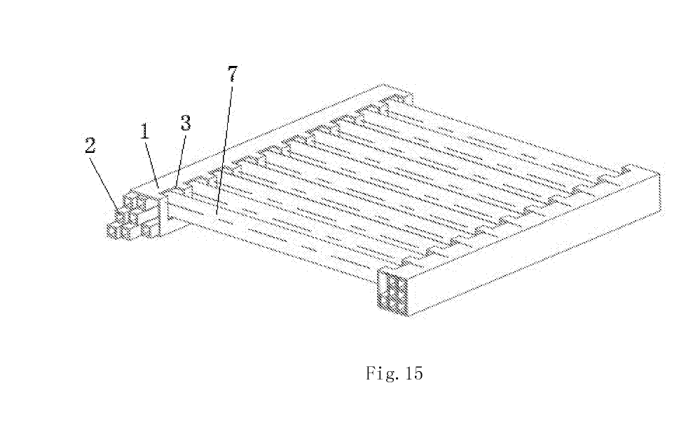

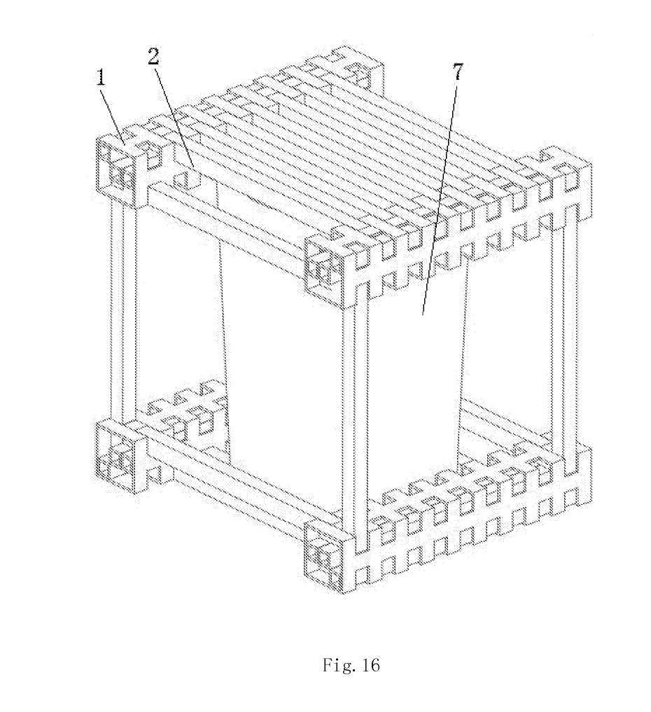

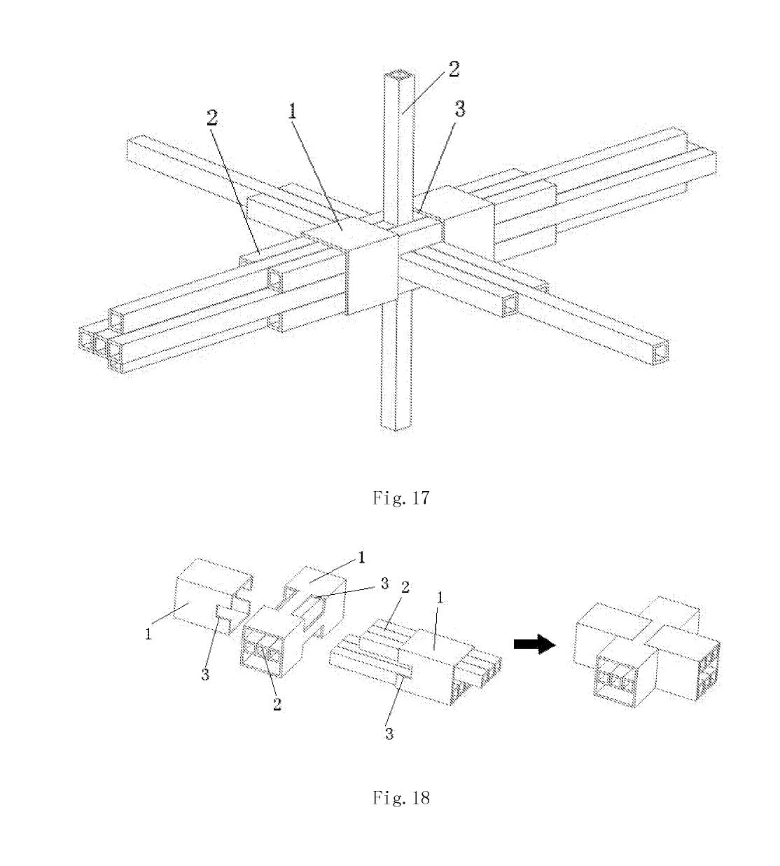

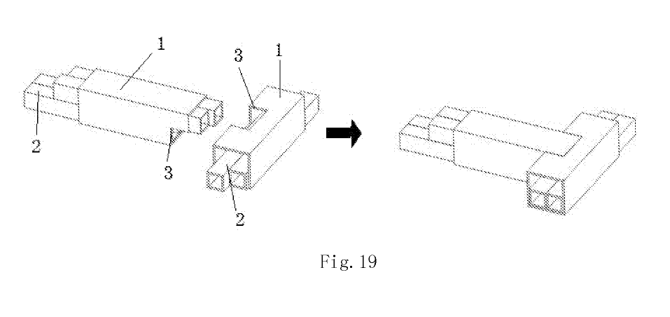

The cross section of the externally wrapping pipe-type frame is in a square shape, the cross section of the internally supported pipe-type frame is in a square shape, the width of an outer frame of the internally supported pipe-type frame is one-third of the width of an inner ring of the externally wrapping pipe-type frame, and therefore a standardized design of a nine patch arrangement is realized. An opening extends two corners of the externally wrapping pipe-type frame and the opening covers five patches of the internally supported pipe-type frames. After seven inner internally supported pipe-type frames are pulled out, the externally wrapping pipe-type frame can be applied to the package of sides of a product (see FIG. 14 for a package method), and more internally supported pipe-type frames can be pulled out to limit the positions of the products.

The part which is not mentioned in the present example is the same as the example IV.

### NINTH EXAMPLE

The present example pulls out four internally supported pipe-type frames which can be used in the package of corners of two products.

The part which is not mentioned in the present example is the same as the example VIII.

### TENTH EXAMPLE

The cross section of the externally wrapping pipe-type frame is in a square shape, the cross section of the internally supported pipe-type frame is in a square shape, the width of an outer frame of the internally supported pipe-type frame is one-third of the width of an inner ring of the externally wrapping pipe-type frame, and therefore a standardized design of a nine patch arrangement is realized. Openings are two groups which are arranged symmetrically, and each opening covers frames three internally supported pipe-type frames. After six internally supported pipe-type frames are pulled out, the present invention can be used in the package of sides of two arrays of products.

### ELEVENTH EXAMPLE

The cross section of the externally wrapping pipe-type frame is in a square shape, the cross section of the internally supported pipe-type frame is in a square shape, the width of an outer frame of the internally supported pipe-type frame is one-third of the width of an inner ring of the externally wrapping pipe-type frame, and therefore a standardized design of a nine patch arrangement is realized. An opening is provided at one corner of the externally wrapping pipe-type frame and the opening covers two patches of the internally supported pipe-type frame. After two internally supported pipe-type frames are pulled out, a mortise structure is formed to limit the position of the lamp pipe, and an end part of the lamp pipe is similar to tenon end which is inserted into the mortise structure.

### TWELFTH EXAMPLE

The cross section of the externally wrapping pipe-type frame is in a square shape, the cross section of the internally supported pipe-type frame is in a square shape, the width of an outer frame of the internally supported pipe-type frame is one-third of the width of an inner ring of the externally wrapping pipe-type frame, and therefore a standardized design of a nine patch arrangement is realized. There are four groups of openings distributing at four corners, each group of openings covering one patch of internally supported pipe-type frames. The width of the opening corresponds to the height or the width of the internally supported pipe-type frame. After six internally supported pipe-type frames are pulled out, a mortise structure is formed. The pulled-out internally supported pipe-type frames form tenon ends and construct a frame structure matched with the mortise to perform a position limitation package for a plant pot. After the plant pot is pulled out, the package structure integrally forms a frame, and the plant pot is placed above the frame. The package structure even can be assembled into a shoe rack or the other racks, and the combination is high in flexibility. The integral package structure can be reused again to form a new group of furniture.

### THIRTEENTH EXAMPLE

A sleeve-type mortise-and-tenon joint structure unit extend from a front left direction towards a right rear direction. In the length direction, an opening is located between two ends of the externally wrapping pipe-type frame; in the direction of the cross section, the opening penetrates through the whole cross section, that is to say, the externally wrapping pipe-type frame is divided into two sections. The opening and a vacant part formed after the internally supported pipe-type frame is pulled out form a mortise structure for the internally supported pipe-type frame being inserted to form a frame.

### FOURTEENTH EXAMPLE

Three sleeve-type mortise-and-tenon joint structure units are provided herein, and the three are connected via a mortise-and-tenon joint structure in sequence to be fixed as a cruciform frame. An opening in the middle sleeve-type mortise-and-tenon joint structure unit satisfies: in the length direction, the opening is located between two ends of the externally wrapping pipe-type frame; in the direction of the cross section, the opening partially covers the cross section. The opening located on the sleeve-type mortise-and-tenon joint structure unit on a left side or a right side satisfies: in the length direction, the opening is located at an end part of the externally wrapping pipe-type frame; in the direction of the cross section, the opening partially covers the cross section.

### FIFTEENTH EXAMPLE

Two sleeve-type mortise-and-tenon joint structure units are provided herein, and the two are connected via a mortise-and-tenon joint structure to be fixed as a T-shaped frame. The opening located on the sleeve-type mortise-and-tenon joint structure unit on a left side satisfies in the length direction, the opening is located at an end part of the externally wrapping pipe-type frame; in the direction of the cross section, the opening partially covers the cross section. The opening located on the sleeve-type mortise-and-tenon joint structure unit on a right side satisfies in the length direction, the opening is located at an end part of the externally wrapping pipe-type frame; in the direction of the cross section, the opening partially covers the cross section.

In addition to the methods mentioned in the above-mentioned examples, the present invention can also be used to package a fragile article with an edge being the shape of a plate, such as a plate; the sleeve-type mortise-and-tenon joint structure unit can also be used to package a fragile article in the shape of a round disk. The number, size and interval of the opening can be reasonably designed according to the number and the size of the product needed to be packed. The internally supported pipe-type frame in the externally wrapping pipe-type frame can also select the other numbers or shapes, and a vacant part obtained after the externally wrapping pipe-type frame being pulling out being able to form a mortise structure with the opening is all that is required. In order to standardize the design, internally supported pipe-type frames with the number being the square of n and the size being approximately the same are placed in the externally wrapping pipe-type frame, for example: the externally wrapping pipe-type frame can be in the shape of a regular triangle and is placed with four regular triangles having the completely same size; the externally wrapping pipe-type frame can be a regular hexagonal shape with six regular hexagonal shapes put inside. These changing methods are all within the scope of protection of the present invention.

The above mentioned examples are preferred embodiments of the present invention, however, the embodiments of the present invention are not affected by the limitation of the above-mentioned examples, any change, modification, replacement, combination and simplification which does not depart from the spirit and principle of the present invention are all equivalent replacement manners and are all comprised in the scope of protection in the present invention.

1. A sleeve-type mortise-and-tenon joint structure unit, characterized in that:
the sleeve-type mortise-and-tenon joint structure unit comprises one externally wrapping pipe-type frame and several internally supported pipe-type frames embedded in the externally wrapping pipe-type frame;
the externally wrapping pipe-type frame is provided with several openings, after some or all of at least one internally supported pipe-type frame is pulled out of an end part of the externally wrapping pipe-type frame, a vacant part is formed in the externally wrapping pipe-type frame, and the openings and the vacant part form a mortise structure.

2. The sleeve-type mortise-and-tenon joint structure unit according to claim 1, characterized in that the cross section of the externally wrapping pipe-type frame is in a regular circular shape or in a regular polygonal shape.

3. The sleeve-type mortise-and-tenon joint structure unit according to claim 1, characterized in that the cross section of the internally supported pipe-type frame is one or more of the regular circular shape and the regular polygonal shape.

4. The sleeve-type mortise-and-tenon joint structure unit according to claim 1, characterized in that the cross section of the externally wrapping pipe-type frame is any one of the regular circular shape and the regular polygonal shape, the cross section of the internally supported pipe-type frame is any one of the regular circular shape and the regular polygonal shape, the number of the internally supported pipe-type frames is the square of n, wherein n is a positive integer, and the shapes and the sizes of the cross sections of all the internally supported pipe-type frames in the one externally wrapping pipe-type frame are all the same.

5. The sleeve-type mortise-and-tenon joint structure unit according to claim 4, characterized in that the width of the openings corresponds to the height or the width of the internally supported pipe-type frames.

6. The sleeve-type mortise-and-tenon joint structure unit according to claim 4, characterized in that the externally wrapping pipe-type frame comprises a buffer edge, and the width of the buffer edge corresponds to the height or the width of the internally supported pipe-type frames; the buffer edge is adjacent to the openings.

7. The sleeve-type mortise-and-tenon joint structure unit according to claim 1, characterized in that in the length direction, the openings are located at an end part of the externally wrapping pipe-type frame or between two ends; in the direction of the cross section, the openings cover a part of the cross section or penetrate through the whole cross section.

8. The sleeve-type mortise-and-tenon joint structure unit according to claim 1, characterized in that an edge of the opening is in a jagged shape.

9. Application of the sleeve-type mortise-and-tenon joint structure unit, characterized in that a product is packed by using not less than two groups of sleeve-type mortise-and-tenon joint structure units as claimed in claim 1; all groups of the sleeve-type mortise-and-tenon joint structure units are provided surrounding the product, and the product is clamped into mortise structures of all groups of sleeve-type mortise-and-tenon joint structure units at the same time; the product together with all groups of the sleeve-type mortise-and-tenon joint structure units are put into a package box, and the internally supported pipe-type frames which are pulled out are padded between the product and the package box.

10. The application of the sleeve-type mortise-and-tenon joint structure unit, characterized in that a frame is constituted by using not less than two groups of sleeve-type mortise-and-tenon joint structure units as claimed in claim 1, the pulled-out internally supported pipe-type frames are inserted into a mortise as a tenon, and the pulled-out internally supported pipe-type frames connect the externally wrapping pipe-type frames together.
